(19) United States
(12) Patent Application Publication
(10) Pub. No.: US 2013/0242092 A1
(43) Pub. Date: Sep. 19, 2013

(54) MOUNTING OF SURVEILLANCE SYSTEMS ONTO FIXTURES

(71) Applicant: UNIVERSAL SURVEILLANCE SYSTEMS, LLC, Rancho Cucamonga, CA (US)

(72) Inventors: Adel O. Sayegh, Rancho Cucamonga, CA (US); Edgardo M. Redublo, Chino Hills, CA (US); Gerald J. Becker, Fontana, CA (US)

(73) Assignee: Universal Surveillance Systems, LLC, Rancho Cucamonga, CA (US)

(21) Appl. No.: 13/737,696

(22) Filed: Jan. 9, 2013

Related U.S. Application Data
(60) Provisional application No. 61/584,792, filed on Jan. 9, 2012.

(51) Int. Cl. H04N 7/18

(52) U.S. Cl. CPC H04N 7/18
USPC 348/143

(57) ABSTRACT

The present invention discloses surveillance systems camera coupled with a pre-existing light fixtures.

### CROSS-REFERENCE TO RELATED APPLICATIONS

This Application claims the benefit of priority of the co-pending U.S. Provisional Utility Patent Application No. 61/584,792, filed Jan. 9, 2012, the entire disclosure of which is expressly incorporated by reference herein. Where a definition or use of a term in the incorporated reference 61/584,792 is inconsistent or contrary to the definition of that term provided herein, the definition of that term provided herein applies and the definition of that term in the reference 61/584,792 does not apply.

### BACKGROUND OF THE INVENTION

1. Field of the Invention

The present invention relates to mounting of surveillance systems onto fixtures and, more particularly, to mounting of surveillance systems wireless cameras onto preexisting light fixtures, including recessed and track lighting fixtures.

2. Description of Related Art

In general, most conventional surveillance systems with cameras (wired or wireless) are mounted onto rigid structures such as walls or ceiling of a building, which increases installation costs due to power and or video cabling, especially within the retail environment where the surveillance system must be inconspicuous and not interfere with the normally perceived “look and feel” of a business. Further, the camera view orientation and angles are permanently limited to only those views from walls or ceiling onto which the camera is mounted.

In particular, even surveillance system cameras that use batteries for power require a separate charger to prolong the use and life of the battery, which, in turn, requires a standardized AC power line. The required AC power line for the camera charger increases the operating cost of the camera installations due to the power line wiring and extra equipment, including labor costs. Not only are the power lines required for even the battery powered surveillance system cameras, but also a separate video cable needs to be laid out and concealed to make the battery powered surveillance system cameras installation effective.

Accordingly, in light of the current state of the art and the drawbacks to current surveillance systems mentioned above, a need exists for a device that would facilitate mounting of a surveillance system with a camera without the complexities of additional power and video cables, permanent alternation of a build structure with which the surveillance systems is to be coupled (such as walls or ceilings), and lower installation costs. Further, a need exists for a device that would facilitate mounting of a surveillance system with a camera that enables adjustments of the surveillance system camera view to a desired orientation even after installation.

### BRIEF SUMMARY OF THE INVENTION

A non-limiting, exemplary aspect of an embodiment of the present invention provides a surveillance system, comprising:

a track lighting system;

a surveillance systems camera;

an intermediary support member that couples the surveillance systems camera with a track lighting system.

Another non-limiting, exemplary aspect of an embodiment of the present invention provides a surveillance system, comprising:

a track lighting system;

a track lighting system receptacle outlet module coupled with the track;

a surveillance systems camera coupled with the track lighting system receptacle outlet module.

Yet another non-limiting, exemplary aspect of an embodiment of the present invention provides a surveillance system, comprising:

a track lighting system;

a power converter circuit for a surveillance systems camera accommodated within an intermediary support member of the track lighting system;

the surveillance systems camera coupled with the track lighting system via the intermediary support member and powered through the power converter circuit.

Still another non-limiting, exemplary aspect of an embodiment of the present invention provides a surveillance system, comprising:

a surveillance systems camera that is coupled with a light socket.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIGS. 1A to 1G are non-limiting, exemplary illustrations of a surveillance system that uses a light fixture in a form of a track lighting system in accordance with an embodiment of the present invention;

FIGS. 2A to 2H are non-limiting, exemplary illustrations of a surveillance system using a light fixture in a form of a track lighting system in accordance with another embodiment of the present invention that eliminates the use of an actual AC adapter plug; and

FIGS. 3A-1 to 3H are non-limiting, exemplary illustrations of a surveillance system using a light fixture in a form of a light socket fixture in accordance with yet another embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

In the description given below, when it is necessary to distinguish the various members, elements, sections/portions, components, or any other aspect or feature of a device from each other, the description will follow reference numbers with a small alphabet character such as (for example) “intermediary support member 106a, 106b, 106c, etc.” If the description is common to all of the various members, elements, sections/portions, components, or any other aspect or feature of a device such as (for example) to all intermediary support members 106a, 106b, 106c, etc, then they are simply referred to with reference number only and with no alphabet character such as (for example) “intermediary support members 106.”

A preferred embodiment is provided that includes a device that facilitates mounting of a surveillance system with a camera without the complexities of additional power and video cables, without permanent alteration of a build structure with which the surveillance systems is coupled (such as walls or ceilings), and has a substantially lower installation costs. Further, various embodiments are provided that include a device that facilitates mounting of a surveillance system with a camera that enables adjustments of the surveillance system camera view to a desired orientation even after installation.

Various embodiments of the present invention provide surveillance systems that use existing light fixtures such as light sockets, track lighting systems, etc., which eliminate the need for the additional power or video lines, eliminating alteration of a structure (e.g., walls or ceiling of a building), and enabling much lower cost of installation while persevering the perceived “look and feel” of a business establishment. Additionally, the various embodiments of the present invention further enable for quick-setup of the surveillance systems camera, its quick and easy modification with respect to camera view orientations and angles (in addition to adjustments with respect to camera translational movement), adds modularity, expandability, and flexibly in terms of network of number and types of surveillance systems cameras installed. Finally, the present invention enables substantial concealment of the surveillance systems camera in that the camera is substantially inconspicuous and is perceived as part of the lighting fixture.

Light fixtures (including track lighting systems) are very well known and commonly found in most buildings such as in a retail environment, offices, and display areas. In general, most light fixtures, including track lighting systems are powered from a main AC power (e.g., 110 VAC) or 12/24 VDC lines, which are compatible with most conventional surveillance systems directly or through an Alternating Current (AC) power adapter. As detailed below, the various embodiments provided in the present invention include the use of a wireless surveillance system installed at or onto lighting fixtures and powered by the lighting fixture (e.g., track lighting systems).

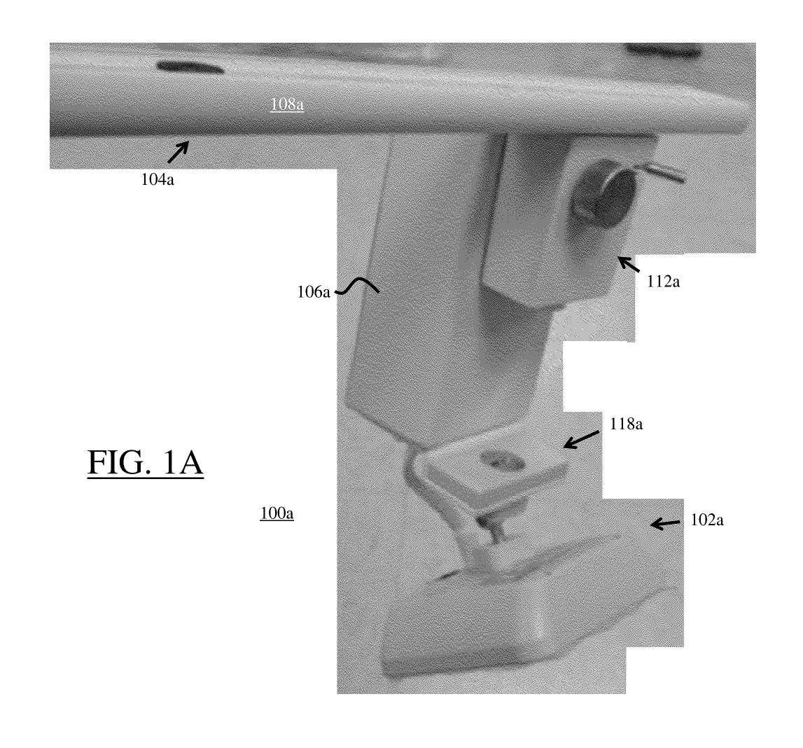

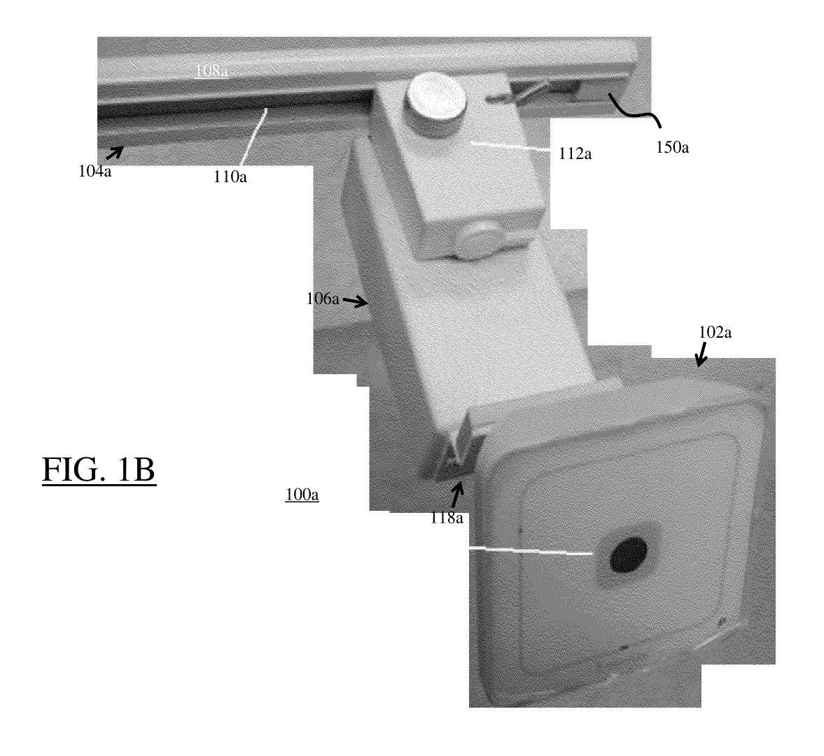

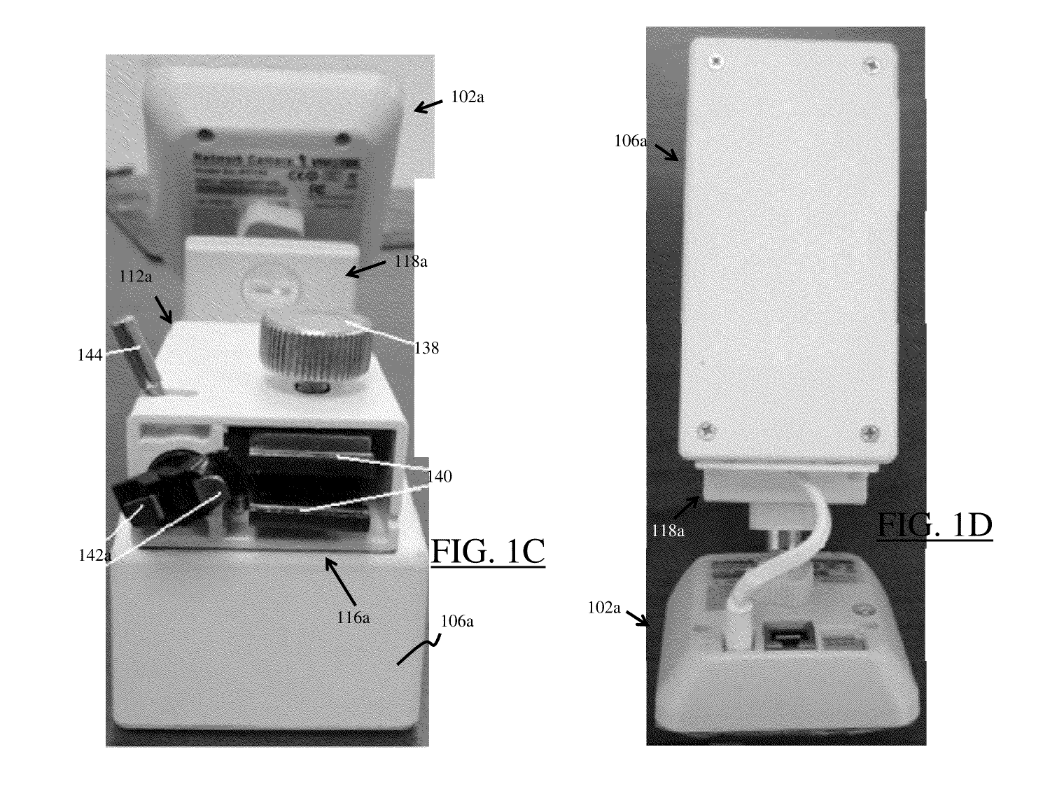

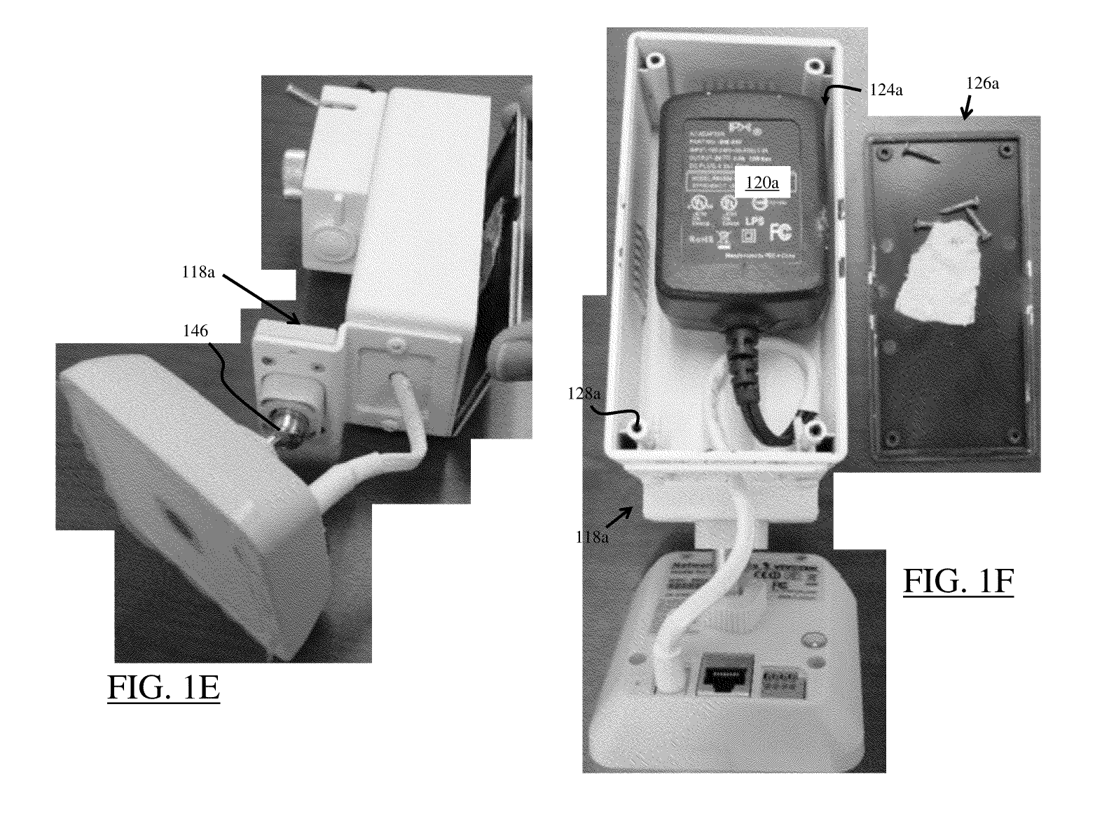

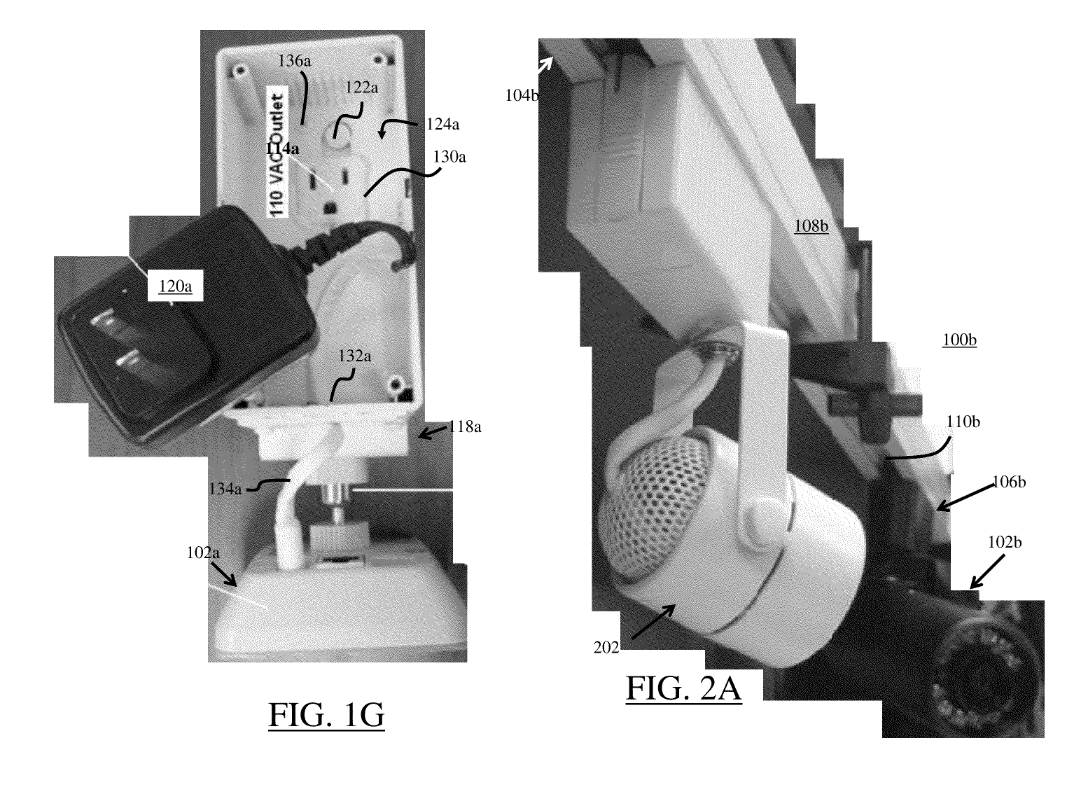

FIGS. 1A to 1G are non-limiting, exemplary illustrations of a surveillance system that uses a light fixture in a form of a track lighting system in accordance with an embodiment of the present invention. As illustrated in FIGS. 1A to 1G, an embodiment of the provides a surveillance system, comprising a track lighting system, a surveillance systems camera, and an optional intermediary support member that couples the surveillance systems camera with a track lighting system.

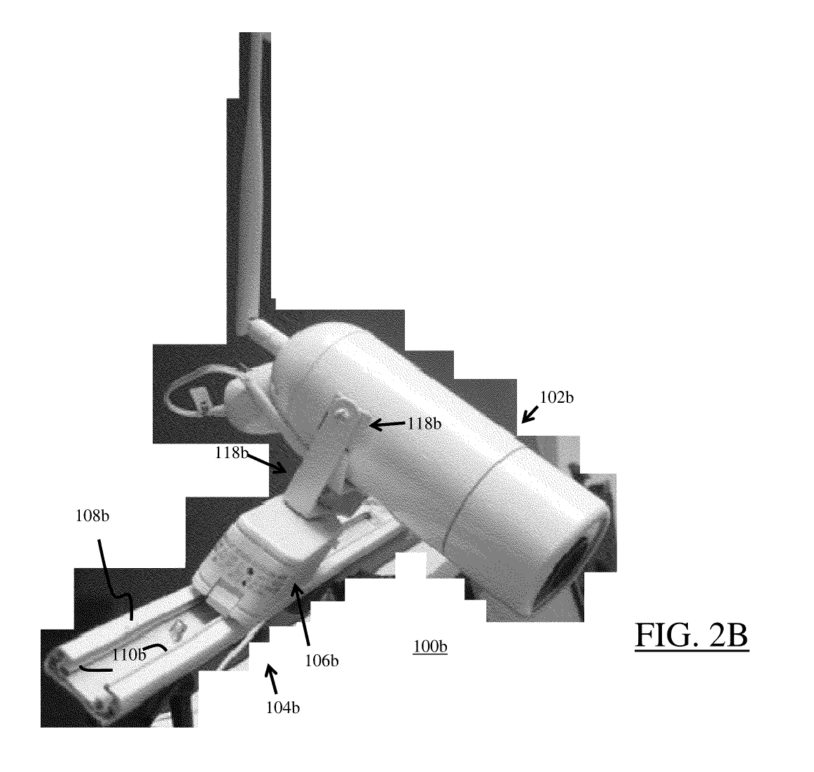

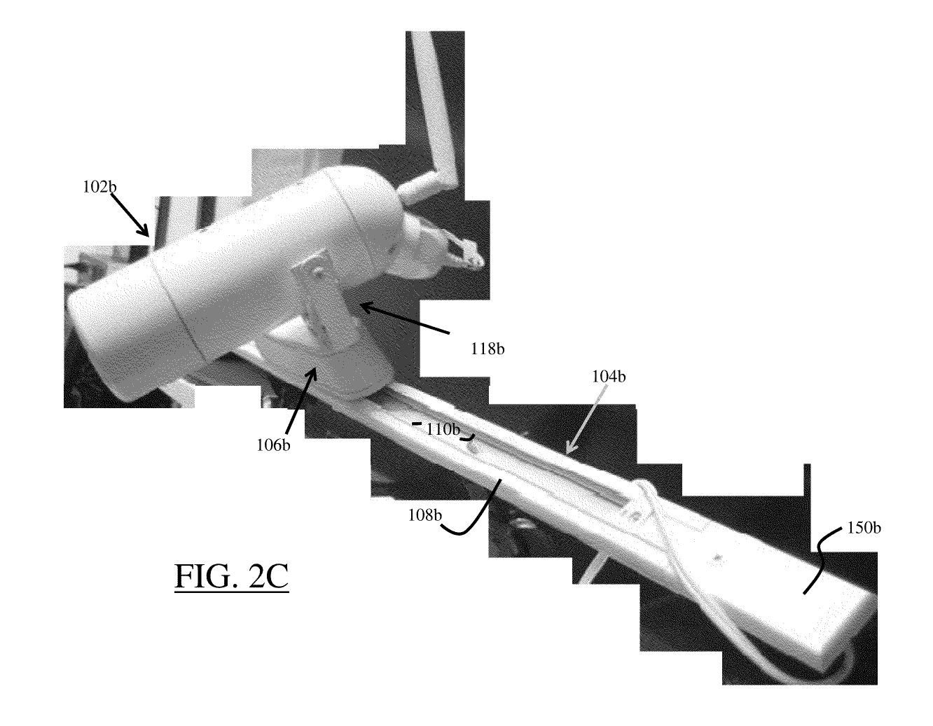

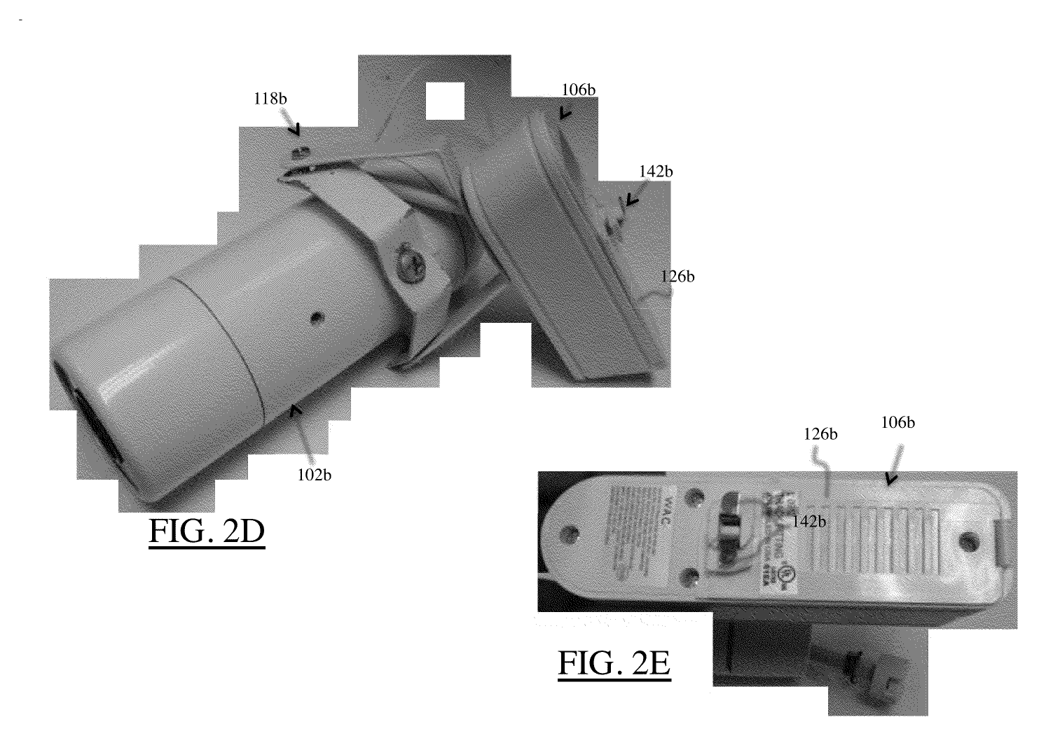

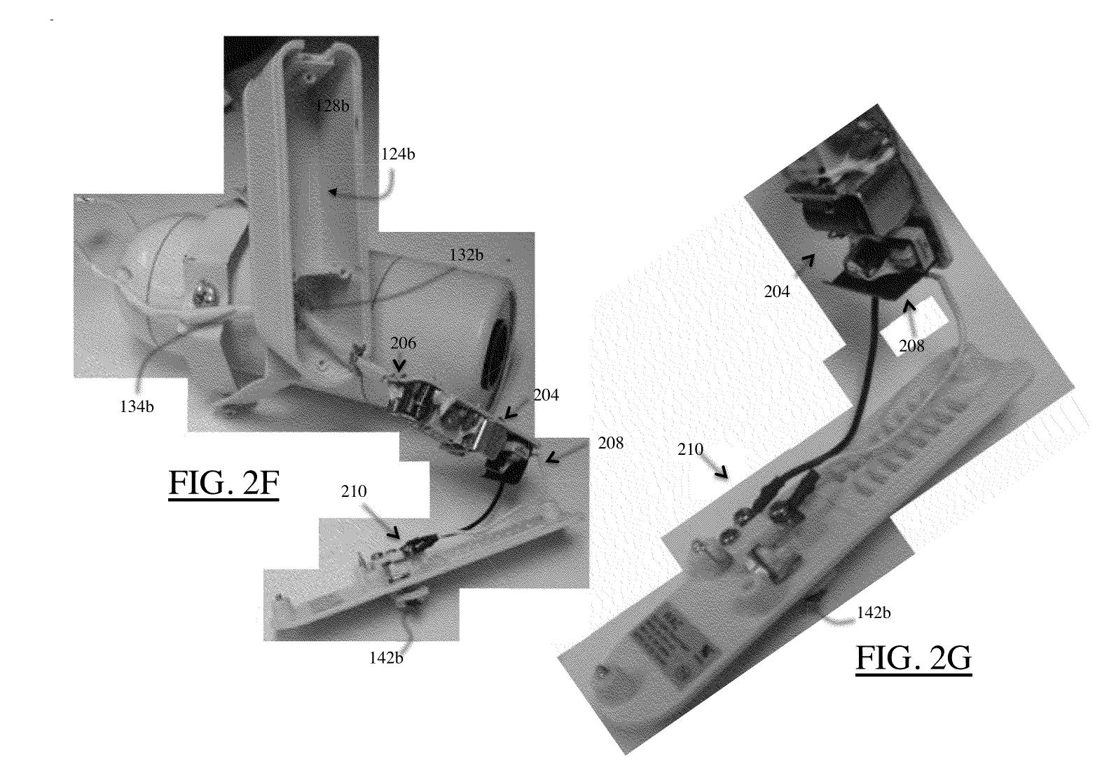

FIGS. 1A to 1G illustrate well-known, conventional track lighting systems 104 as a non-limiting, exemplary light fixture that includes a track 108 for supporting fixtures such as lighting fixtures 202 (FIG. 2A), with the track 108 including a conductive raceway 110 for conducting electricity to the various fixtures thereon. The track lighting systems 104 further include a track lighting system adapter 150 that receives power from AC mains and conducts power to the track 108. Most track lighting systems 104 may also optionally include well known track lighting system receptacle outlet module 112 for plugging in additional electric equipment to the track lighting system 104, which if not included, may be easily purchased separately from third party vendors.

As illustrated in FIGS. 1A to 1G, an embodiment of the present invention provides a surveillance system 100a, comprising the track lighting system 104, a surveillance systems camera 102, and an intermediary support member 106a that couples the surveillance systems camera 102 with the track lighting system 104. The track lighting system receptacle outlet module 112a is coupled with the intermediary support member 106a at a first end and the track 110 at a second end 116a (by clamps 140 and electrical contacts 142a), with the module 112a receiving the AC power plug adapter of the surveillance systems camera 102 to power the camera.

As further illustrated, the present invention further utilizes well-known surveillance systems camera 102 that are comprised of wireless transceiver antenna systems for transmission and reception of signals (e.g., video, audio, data, etc.), and may be associated with and include an Internet Protocol (IP) address. Such cameras also include an adjustable base-stand 118a (with swivel connection 146) that is used to couple the surveillance systems camera 102 with the intermediary support member 106a of the this embodiment of the present invention. In general, the surveillance system camera 102 also includes an Alternating Current (AC) power plug adapter 120a (that is coupled with the tack lighting system 104) for supply of power from the track lighting system 104 to the surveillance systems camera 102.

As stated above, this embodiment of the present invention exemplarily illustrated in FIGS. 1A to 1G provides an intermediary support member 106a that couples an adjustable base-stand 118a of the surveillance systems camera 102 with a track lighting system receptacle outlet module 112a, with the track lighting system receptacle outlet module 112a coupled with the track lighting system 104 by the clamps 140. The intermediary support member 106a is connected with the track lighting system receptacle outlet module 112a by a fastener 136a, non-limiting example of which may include at least one screw. The intermediary support member 106a conceals an Alternating Current (AC) power plug adapter 120a of the surveillance systems camera 102, with a first end connected to the surveillance systems camera 102, and a second end thereof connected to a track lighting system receptacle outlet module 112a, which receives power from the track lighting system 104.

As best illustrated in FIGS. 1E to 1G, the intermediary support member 106a includes an interior chamber 124a that accommodates and houses an Alternating Current (AC) power plug adapter 120a of the surveillance systems camera 102, and includes a lid 126 that encloses the interior chamber 124, with the interior chamber 124 comprising posts 128 that receive the fasteners of the lid 126. Further included is a receptacle outlet hole 130a for receiving a receptacle outlet 114a of the track lighting system receptacle outlet module 112a, which faces the interior chamber 124a and is used to plug the AC power plug adapter 120a of the surveillance systems camera 102. Additionally, the intermediary support member 106a also includes a release actuator hole for receiving a release actuator 122a of the track lighting system receptacle outlet module 112a, which faces the interior chamber 124a and is used to release the track lighting system receptacle outlet module 112a from the track 108 of the track lighting system 104, enabling complete detachment and removal of the track lighting system receptacle outlet module 112a form the track 108. The intermediary support member 106a also includes an aperture 132a for enabling insertion of a cable 134a of an Alternating Current AC power plug adapter 120a connecting the surveillance systems camera 102 with the receptacle outlet 114a. Accordingly, as illustrated in FIGS. 1A to 1G, the surveillance system camera 102 is fully and completely installed without the complexities of additional power and video cables, permanent alterations of a build structure with which the surveillance systems is coupled (such as walls or ceilings), and has a substantially lower installation costs. Further, the surveillance system camera view is easily adjusted to a desired orientation even after installation when using a lighting fixture such as a track lighting system 104.

FIGS. 2A to 2H are non-limiting, exemplary illustrations of a surveillance system using a light fixture in a form of a track lighting system in accordance with another embodiment of the present invention that eliminates the use of the actual, physical AC adapter plug. The surveillance system 100b illustrated in FIGS. 2A to 2H includes similar corresponding or equivalent components, interconnections, functional, and or cooperative relationships as the surveillance system 100a that is shown in FIGS. 1A to 1G, and described above. Therefore, for the sake of brevity, clarity, convenience, and to avoid duplication, the general description of FIGS. 2A to 2H will not repeat every corresponding or equivalent component, interconnections, functional, and or cooperative relationships that has already been described above in relation to surveillance system 100a that is shown in FIGS. 1A to 1G.

As illustrated in FIGS. 2A to 2H, the surveillance system 100b is comprised of a track lighting system 104, which includes a power converter circuit 204 (FIGS. 2G and 2H) for the surveillance systems camera 102 accommodated within an intermediary support member 106b of the track lighting system 104. The surveillance systems camera 102 is coupled with the track lighting system 104 via the intermediary support member 106b and powered through the power converter circuit 204. It should be noted that power converter circuits 204 (an AC and or DC power adapter circuit) is conventional and well known, and is used with electrical devices that require power but do not contain internal components to derive the required voltage and power from mains power.

The surveillance systems camera 102 is comprised of a wireless transceiver antenna system for transmission and reception of signals and an adjustable base-stand 118b coupling the surveillance systems camera 102 with the intermediary support member 106b. The intermediary support member 106b houses the power converter circuit 204 for the surveillance systems camera 102, with a first end 206 of the power converter circuit 204 coupled with the surveillance systems camera 102 (via cable 134b), and a second end 210 thereof connected to electric contacts 142b of the intermediary support member 106b. The electric contacts 142b receive power from a conductive raceway 110b of tracks 108b of the track lighting system 104.

The intermediary support member 106a includes an interior chamber 124b that accommodates and houses the power converter circuit 204 for the surveillance systems camera 102 without the need for an actual AC plug adapter 120a. Also included is a lid 126b that encloses the interior chamber 124b; with the interior chamber 124b comprising posts 128b that receive the fasteners of the lid 126b. The lid 126b further includes the abovementioned set of electric contacts 142b, which face the exterior of the interior chamber 124b. An aperture 132b is included for enabling insertion of a cable 134b of the surveillance systems camera 102 for connection with the power converter circuit 204 at first end 206.

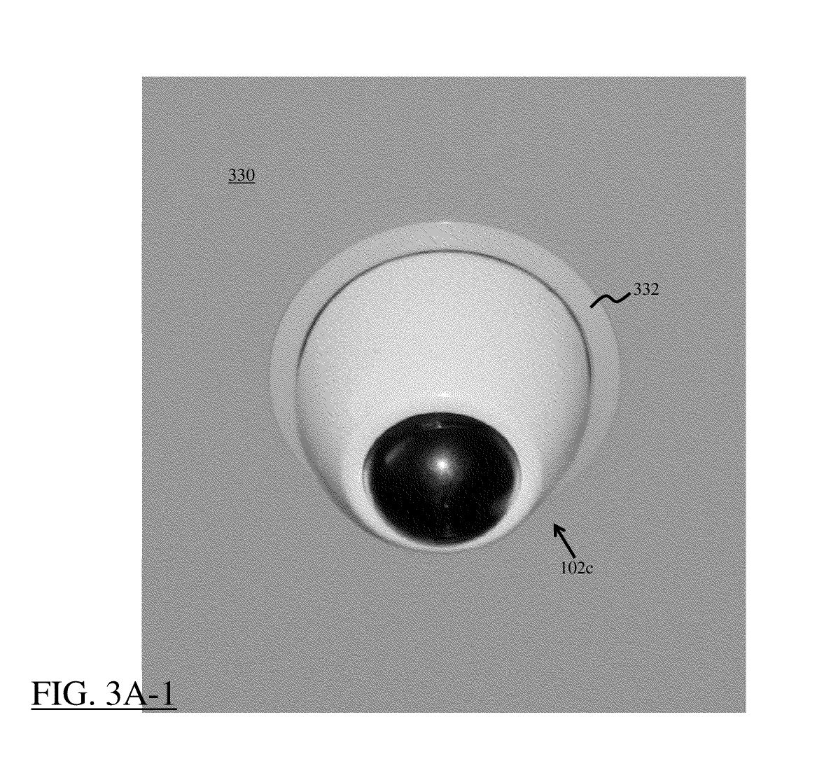

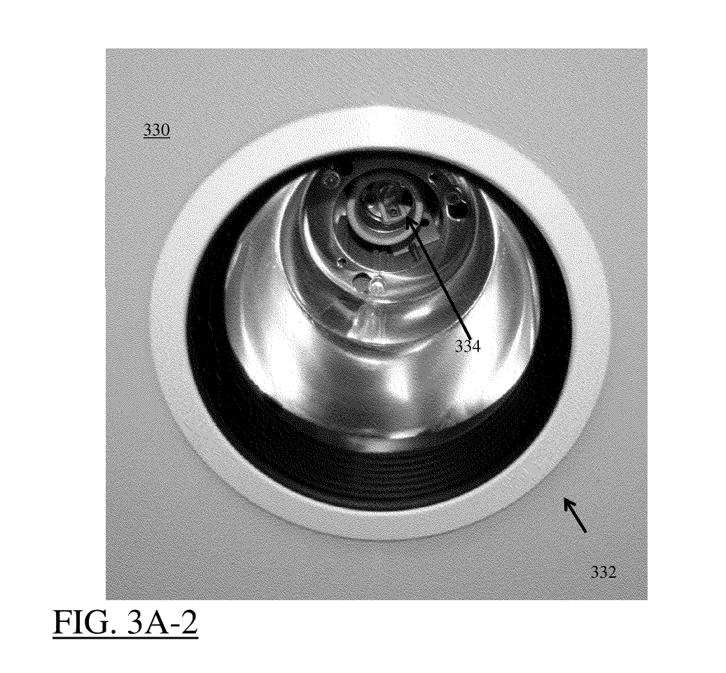

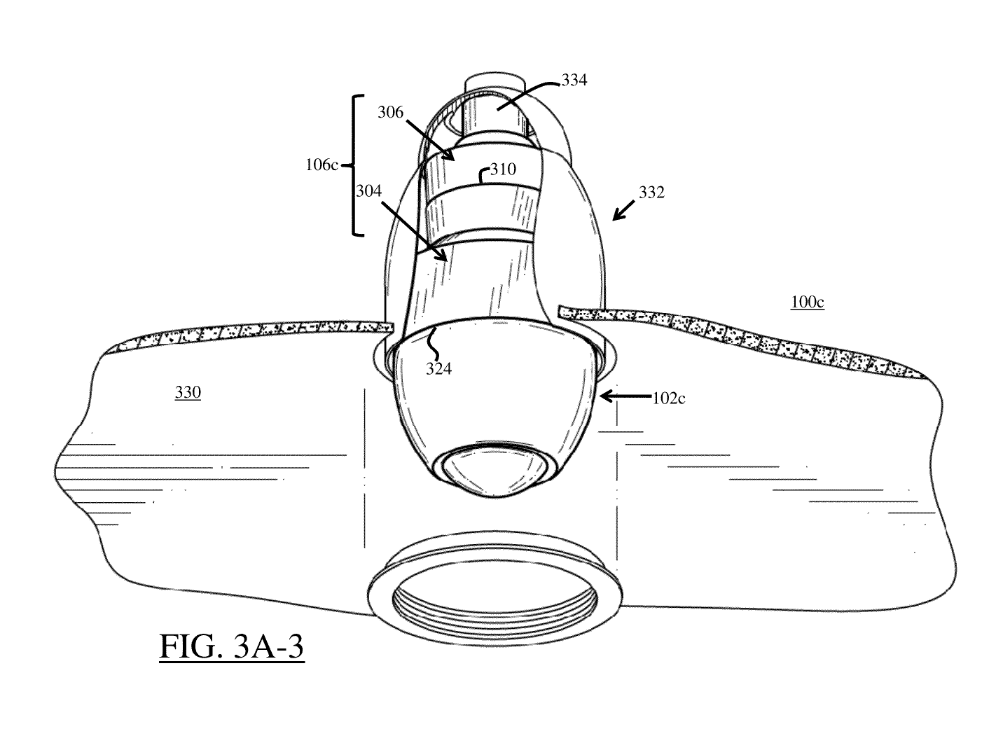

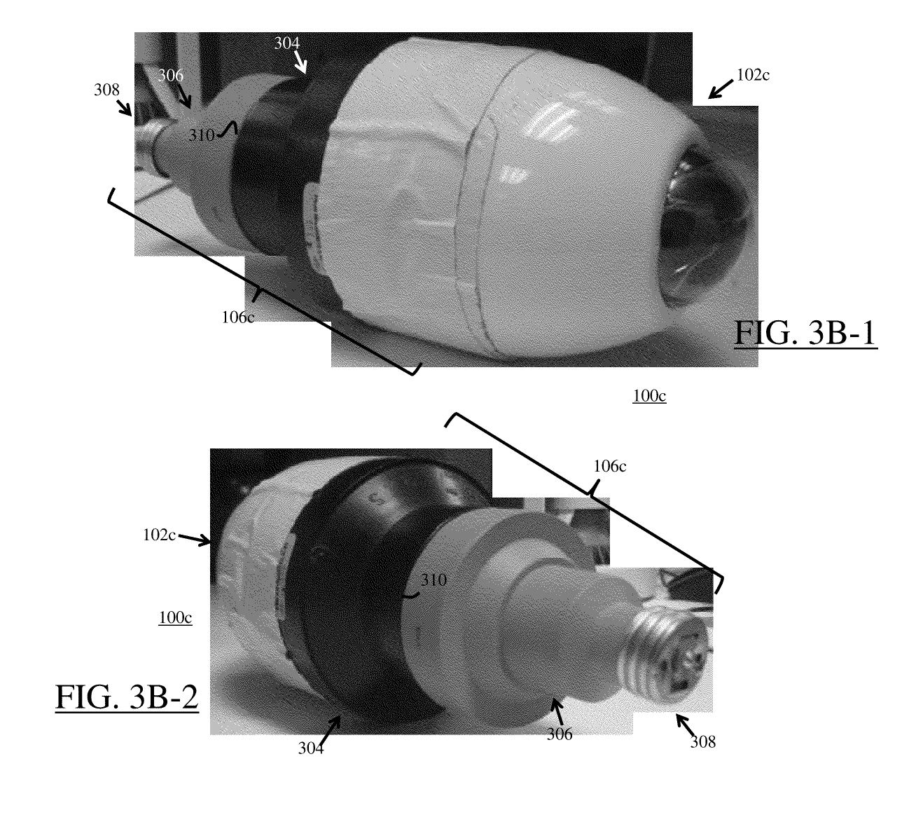

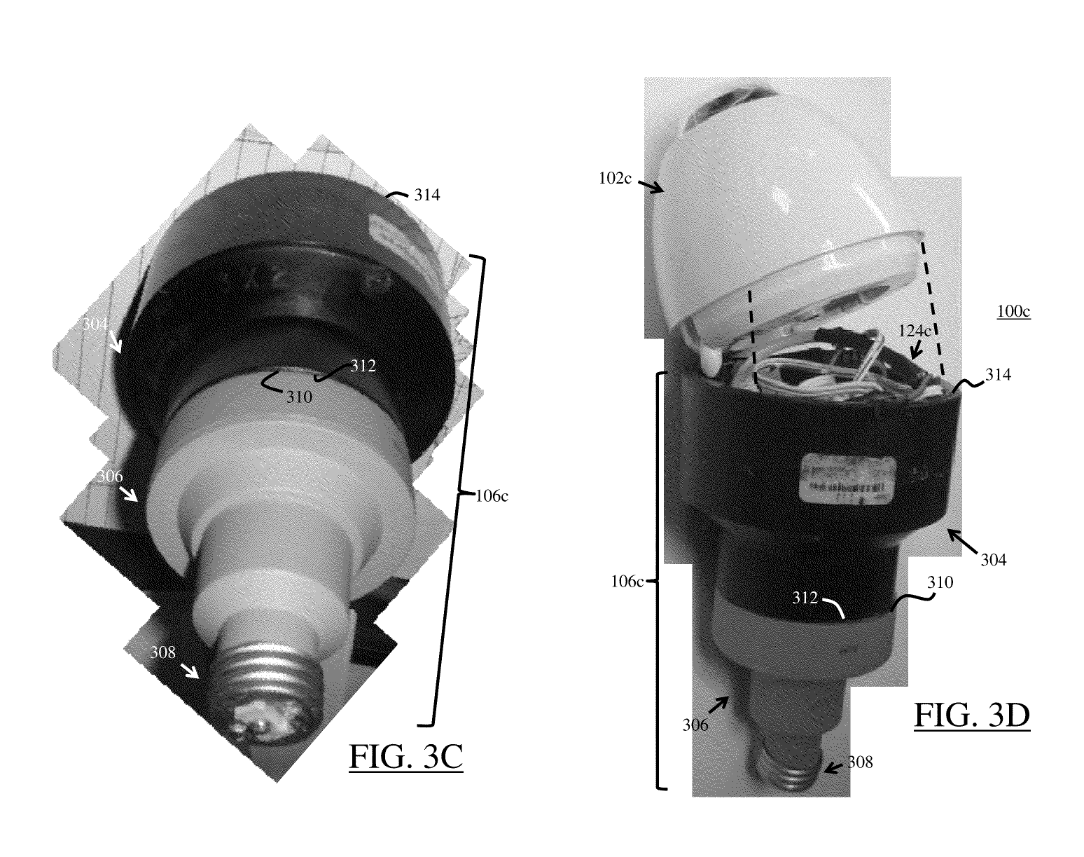

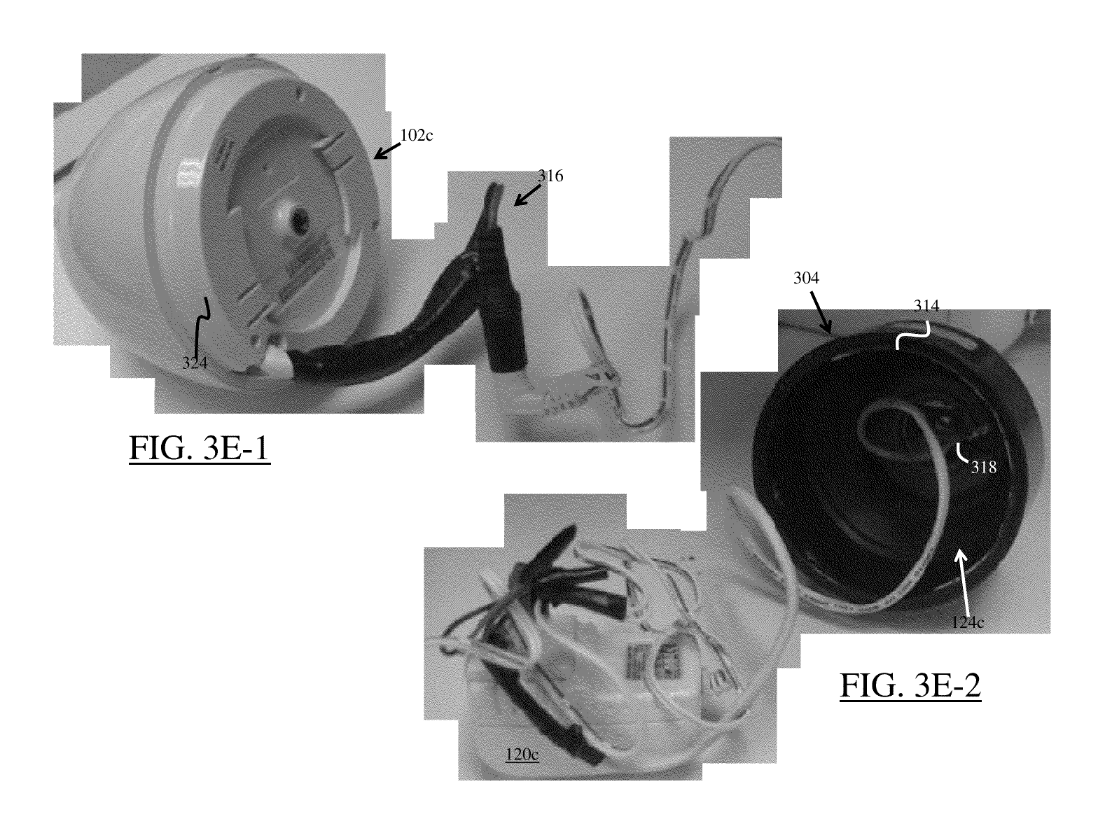

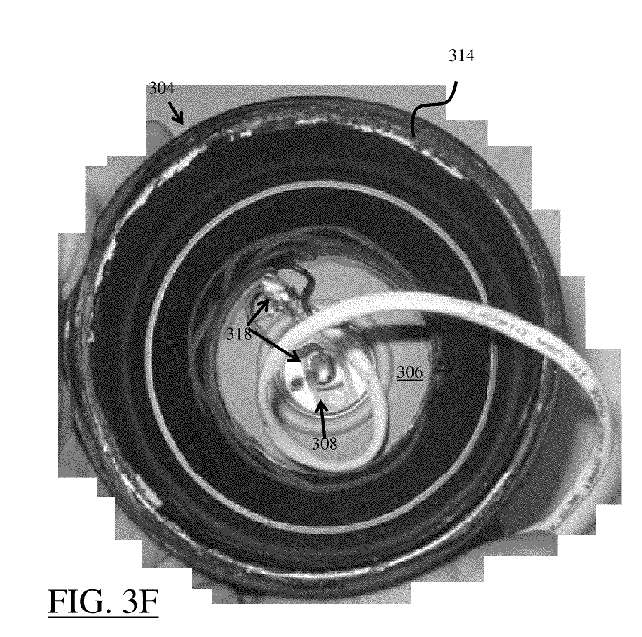

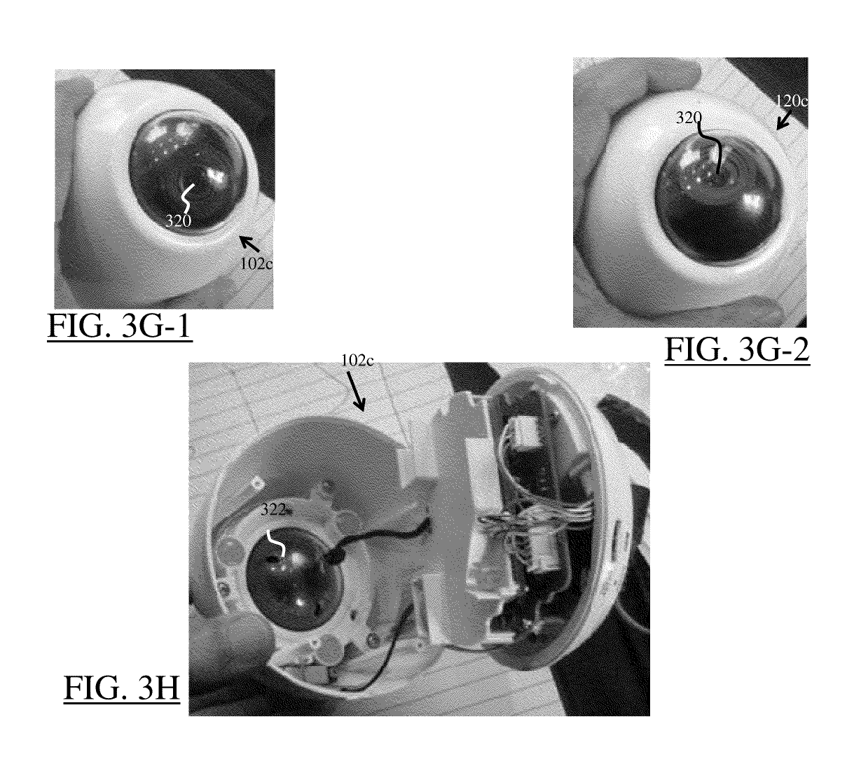

FIGS. 3A to 3H are non-limiting, exemplary illustrations of a surveillance system using well known and conventional light fixture in a form of a well known and conventional light socket fixture in accordance with yet another embodiment of the present invention. The surveillance system 100c illustrated in FIGS. 3A to 3H includes similar corresponding or equivalent components, interconnections, functional, and or cooperative relationships as the surveillance systems 100a and 100b that is shown in

FIGS. 1A to 2H, and described above. Therefore, for the sake of brevity, clarity, convenience, and to avoid duplication, the general description of FIGS. 3A to 3H will not repeat every corresponding or equivalent component, interconnections, functional, and or cooperative relationships that has already been described above in relation to surveillance systems 100a and 100b that is shown in FIGS. 1A to 2H.

As illustrated in FIGS. 3A-1 and 3H, the surveillance system 100c is comprised of a surveillance systems camera 102c that is coupled with an existing (well known and conventional) light socket fixture 332 (best shown in FIG. 3A-2 and 3A-3), which in this non-limiting exemplary instance is a well-known and conventional recessed light socket fixture 332. The surveillance system 100c is further comprised of an intermediary support member 106c that is comprised of a light socket adapter 306 that allows for coupling the surveillance systems camera 102c with an existing light socket fixture 332. As illustrated, the light socket adapter 306 couples with a light socket fixture 332 at a first end 308 and the surveillance systems camera 102c at a second end 310. The first end 308 of the light socket adapter 306 is a member in a form of an electric contact threaded fastener that screws onto the light socket fixture 332, with the second end 310 of the light socket adapter 306 accommodating the surveillance systems camera 102c. In other words, just as a light bulb is screwed onto a light socket fixture 332, so does the surveillance system camera 102c facilitated by the light socket adapter 306, where the first end 308 of the light socket adapter 306 is screwed onto the female connector portion 334 (best shown in FIG. 3A-2 and 3A-3) of the light socket fixture 332.

As further illustrated, the intermediary support member 106c further includes an optional extender member 304 for use with recessed light socket fixtures 332. The extender member 304 longitudinally extends the length of the light socket adapter 306 to enable the bottom 324 of the surveillance systems camera 102c to extend out of the recessed portion of the ceiling 330 for recessed light socket fixtures 332 (best shown in FIG. 3A-1 and 3A-3). The extender member 304 may also provide additional housing for the circuit for the power converter circuit (or AC adapter plug, which ever is used) for powering the surveillance systems camera 102c (similar to the above described embodiments shown in FIGS. 1A to 2H). In general, the perimeter of the extender member 304 is wider so that the bottom 324 of the surveillance systems camera 102c can simply fit on top perimeter 314 of the extender member 304 with no further modifications. The perimeter edge 312 of the extender member 304 is coupled with the perimeter edge 310 of the light socket adapter 306.

As illustrated in FIGS. 3D to 3F, the intermediary support member 106c conceals an Alternating Current (AC) power plug adapter 120c of the surveillance systems camera 102c, with a first end 316 connected to the surveillance systems camera 102c, and a second end 318 thereof connected to the first end 308 of the light socket adapter 306, which receives power from the light socket fixture 332. It should be noted that the AC power plug adapter 120c may easily be replaced with a power converter circuit as shown and described in relation to FIGS. 2A to 2H. As best illustrated in FIGS. 3G-1 to 3H, in this non-limiting, exemplary embodiment, the surveillance systems camera 102c is comprised of a wireless mini dome camera that has a transceiver antenna system for transmission and reception of signals, and includes an adjustable rotating lens 320 housed with a rotating globe 322 for modifying the camera view in any direction even if and when the surveillance systems camera 102c is fixed within the light socket fixture 332. Accordingly, as illustrated in FIGS. 1A to 3H, the surveillance system camera 102 is fully and completely installed without the complexities of additional power and video cables, without permanent alterations of a build structure with which the surveillance systems is coupled (such as walls or ceilings), and has a substantially lower installation costs. Further, the surveillance system camera view is easily adjusted to a desired orientation even after installation when using a conventional lighting fixture.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, an intermediary support member may be equipped with gooseneck type of IP camera, or an intermediary support member fashioned as a hanging chandelier type or base, with the surveillance camera 102c assembly and installed through the incandescent bulb receptacle. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A surveillance system, comprising:
a track lighting system;
a surveillance systems camera;
an intermediary support member that couples the surveillance systems camera with a track lighting system.

2. The surveillance system as set forth in claim 1, wherein:
the track lighting system is comprised of:
a track for supporting fixtures, with the track including a conductive raceway for conducting electricity;
a tack lighting system adapter that receives power from mains and conducts power to the track; and
a track lighting system receptacle outlet module coupled with the intermediary support member at a first end and the track at a second end.

3. The surveillance system as set forth in claim 1, wherein:
the surveillance systems camera is comprised of:
a wireless transceiver antenna system for transmission and reception of signals; and
an adjustable base-stand coupling the surveillance systems camera with the intermediary support member.

4. The surveillance system as set forth in claim 3, wherein:
the surveillance systems camera further includes an Alternating Current (AC) power plug adapter for supply of power from the track lighting system to the surveillance systems camera.

5. The surveillance system as set forth in claim 3, wherein: the surveillance systems camera includes an Internet Protocol (IP) address.

6. The surveillance system as set forth in claim 1, wherein:
the intermediary support member couples an adjustable base-stand of the surveillance systems camera with a track lighting system receptacle outlet module via the intermediary support member, with the track lighting system receptacle outlet module coupled with the track lighting system.

7. The surveillance system as set forth in claim 7, wherein:
the intermediary support member is connected with the track lighting system receptacle outlet module by a fastener.

8. The surveillance system as set forth in claim 7, wherein:
the intermediary support member and the track lighting system receptacle outlet module are comprised of a single piece.

9. The surveillance system as set forth in claim 1, wherein:
the intermediary support member conceals an Alternating Current (AC) power plug adapter of the surveillance systems camera, with a first end connected to the surveillance systems camera, and a second end thereof connected to a track lighting system receptacle outlet module, which receives power from the track lighting system.

10. The surveillance system as set forth in claim 1, wherein:
the intermediary support member includes:
an interior chamber that accommodates and houses an Alternating Current (AC) power plug adapter of the surveillance systems camera;
a lid that encloses the interior chamber;
a receptacle outlet hole for receiving a receptacle outlet of the track lighting system receptacle outlet module, which faces the interior chamber and is used to plug the AC power plug adapter of the surveillance systems camera;
a release actuator hole for receiving a release actuator of the track lighting system receptacle outlet module, which faces the interior chamber and is used to release the track lighting system receptacle outlet module from the track of the track lighting system, enabling complete detachment and removal of the track lighting system receptacle outlet module form the track; and
an aperture for enabling insertion of a cable of an Alternating Current AC power plug adapter connecting the surveillance systems camera with the receptacle outlet.

11. A surveillance system, comprising:
a track lighting system;
a track lighting system receptacle outlet module coupled with the track;
a surveillance systems camera coupled with the track lighting system receptacle outlet module.

12. A surveillance system, comprising:
a track lighting system;
a power converter circuit for a surveillance systems camera accommodated within an intermediary support member of the track lighting system;
the surveillance systems camera coupled with the track lighting system via the intermediary support member and powered through the power converter circuit.

13. The surveillance system as set forth in claim 12, wherein:
the surveillance systems camera is comprised of:
a wireless transceiver antenna system for transmission and reception of signals; and
an adjustable base-stand coupling the surveillance systems camera with the intermediary support member.

14. The surveillance system as set forth in claim 13, wherein:
the intermediary support member houses the power converter circuit for the surveillance systems camera, with a first end of the power converter circuit coupled with the surveillance systems camera, and a second end thereof connected to electric contacts of the intermediary support member;
the electric contacts receive power from a conductive raceway of tracks of the track lighting system.

15. The surveillance system as set forth in claim 14, wherein:
the intermediary support member includes:
an interior chamber that accommodates and houses the power converter circuit for the surveillance systems camera;
a lid that encloses the interior chamber;
the lid further includes a set of electric contacts, facing outside the interior chamber;
an aperture for enabling insertion of a cable of the surveillance systems camera for connection with the power converter circuit at first end.

16. A surveillance system, comprising:
a surveillance systems camera that is coupled with a light socket.

17. The surveillance system as set forth in claim 16, further comprising:
an intermediary support member that is comprised of a light adapter socket that couples with a light socket at a first end and the surveillance systems camera at a second end.

18. The surveillance system as set forth in claim 17, wherein:
the first end of the light adapter socket is a member in a form of an electric contact fastener that couples onto the light socket, and the second end of the light adapter socket accommodates the surveillance systems camera.

19. The surveillance system as set forth in claim 18, wherein:
intermediary support member further includes an extender member for use with recessed light sockets.

20. The surveillance system as set forth in claim 19, wherein:
the intermediary support member conceals an Alternating Current (AC) power plug adapter of the surveillance systems camera, with a first end 316 connected to the surveillance systems camera, and a second end 318 thereof connected to the first end of the light adapter socket, which receives power from the light socket.

21. The surveillance system as set forth in claim 16, wherein:
the surveillance systems camera is comprised of:
a wireless mini dome camera that has a transceiver antenna system for transmission and reception of signals; and
an adjustable rotating lens housed with a rotating globe for modifying the camera view.
